(19) United States
(12) Patent Application Publication
(10) Pub. No.: US 2007/0175567 A1
(43) Pub. Date: Aug. 2, 2007

(54) Methods and apparatus for making tires and for converting an assembly line for making different types of tires

(76) Inventor: David Stahl, Greer, SC (US)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 11/271,192

(22) Filed: Nov. 10, 2005

(51) Int. Cl. B29D 30/00

(52) U.S. Cl. 156/111; 156/396

(57) ABSTRACT

A tire manufacturing assembly line is disclosed which can be reconfigured for making different types of tires in shorter runs. The assembly line can interchangeably use components from centralized preparation or integrated preparation, and interchangeably use storage reels of any form from the centralized preparation.

### BACKGROUND OF THE INVENTION

The present invention relates to methods and apparatus for making tires using an assembly-line technique.

Tires have heretofore been made by various processes. In one traditional process, a green tire carcass is built on a building drum by an operator working at a fixed station. Various green tire components are sequentially fed from respective spools to the drum and are applied thereon one upon the other as the drum rotates. Then, a belt/tread package is applied to the carcass, and the package is vulcanized.

Tires have also been made using an assembly-line approach, wherein a building drum is moved sequentially from one station to the next, and the various green tire components are applied at respective stations. That conventional assembly-line technique has been ideally suited for making extended runs of a given type of tire. However, due to the difficulty to reconfigure the assembly line, that technique has not been particularly useful in situations where tires of different types, i,e., different styles and/or complexities, are to be made in shorter runs. That is, different types of tires require that different green tire components be applied along the assembly line, necessitating that the assembly line be reconfigured in order to accomplish this. However, the reconfiguring of known assembly lines is a difficult and time consuming operation, so assembly lines have not proven to be practicable for short manufacturing runs.

Tires have been built using various types of pose technology, e.g., so-called centralized preparation and integrated preparation. In the case of the former, tire components have been formed in a centralized preparation shop and transported on reels to the assembly machines. In the case of integrated preparation, the tire components are formed directly on the tire assembly machine. Heretofore, assembly machines have been specialized to match the type of components being handled. That is, a machine that handles components from centralized preparation is designed specifically for centralized preparation components. Conversely, a machine that handles integrated preparation is designed specifically for integrated components. However, due to the difficulties involved in reconfiguring the assembly machines from one technology to another, few conversions have ever been made. Furthermore, this specialization has prevented the co-habitation and selective use of either centralized preparation or integrated preparation to meet specific needs.

Tire assembly machines and tire assembly factories have been built by many companies, in many environments, in many different generations of development, and with no standards for application of “in process” storage methods. That is, factories that use centralized preparation of components will store the components on reels of non-standard diameters, non-standard shaft or core sizes, and non-standard drive methods. While this can be a manageable inconvenience within a given company, the evolution of tire manufacturing has dramatically compounded the problem. Mergers and acquisitions bring forth the situation whereby a company has a wide diversity of storage reel solutions. As tire assembly machines are conceived or relocated from one factory to another, significant effort and resources are required to reconfigure the machines for the unique environment.

Therefore, it would be desirable to provide a tire-making assembly line which can be easily and quickly reconfigured for making different types of tires, and which could interchangeably use components from centralized preparation or integrated preparation, and interchangeably use storage reels of any form from the centralized preparation.

### BRIEF DESCRIPTION OF THE DRAWING

The objects and advantages of the invention will become apparent from the following detailed description of preferred embodiments thereof in connection with the accompanying drawings in which like numerals designate like elements and in which:

FIG. 1 is a schematic plan view of a tire-making assembly line according to the invention for making a first type of tire.

FIG. 2 is a side elevational view of a component-applying station of FIG. 1 with a support floor shown in vertical cross section.

FIG. 3 is a plan view of two of the component applying stations, depicting an array of holes in the support floor, and guide tables for guiding tire components.

FIG. 4 is a top perspective view of a component-applying station according to the invention.

FIG. 5 is a view similar to FIG. 1 after the assembly line has been converted for making of a different type of tire.

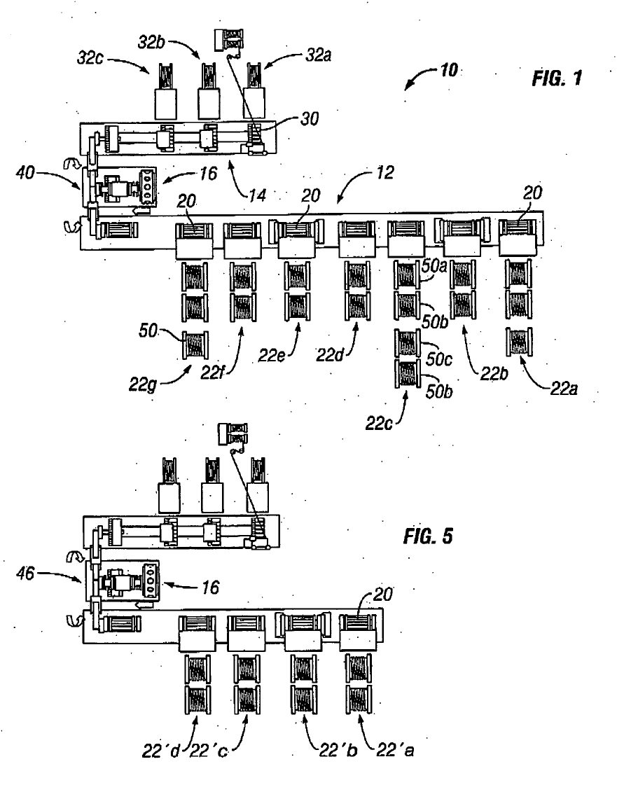

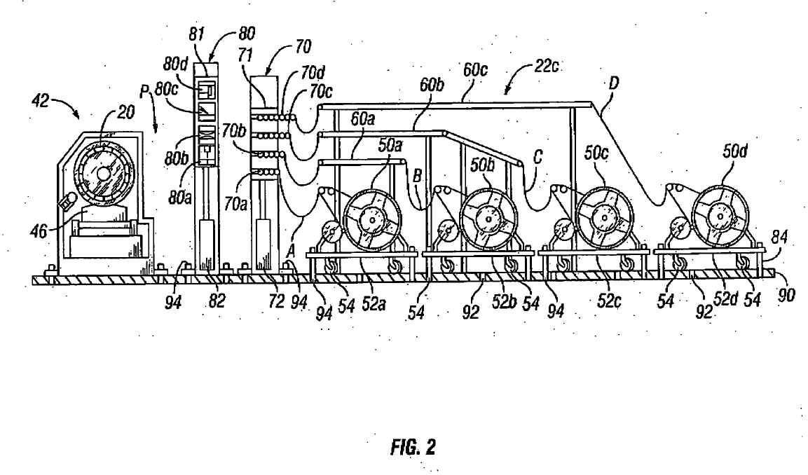

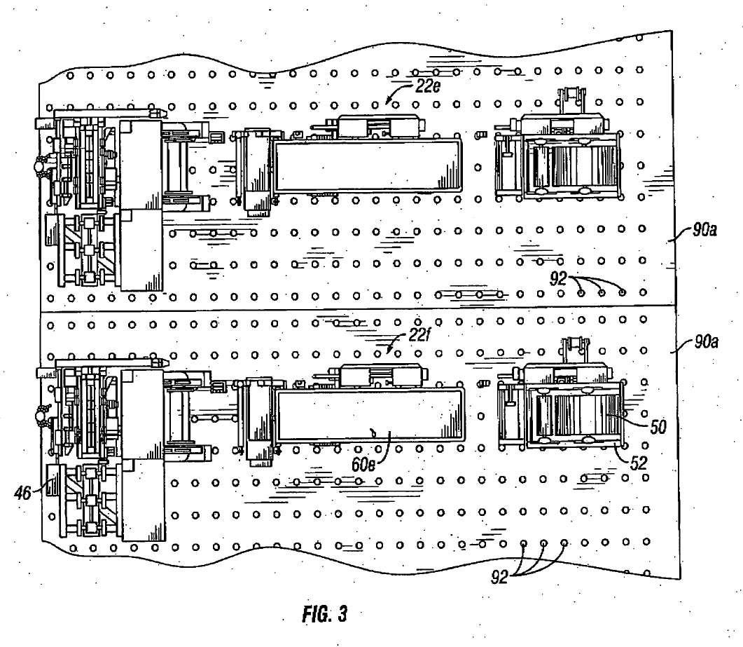

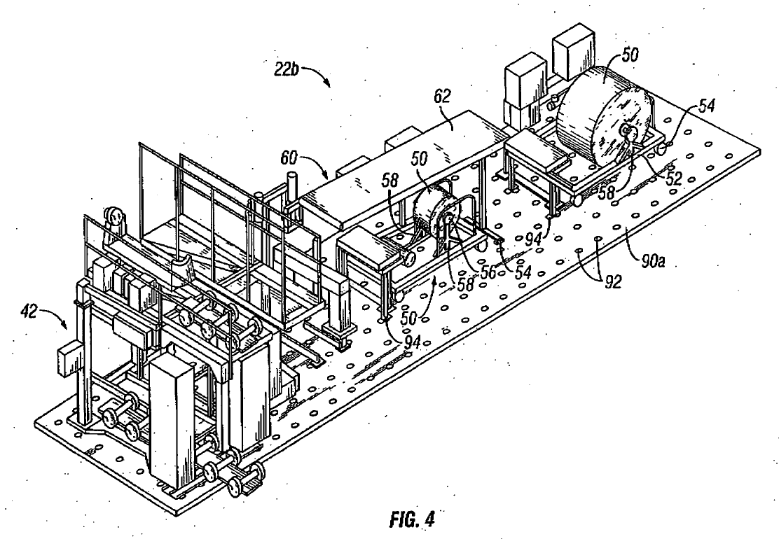

### DETAILED DESCRIPTION OF A PREFERRED EMBODIMENT

Depicted schematically in plan view in FIG. 1 is a tire-building machine (assembly machine) 10 which employs an assembly-line approach. The machine includes a carcass line 12 and a belt/tread line 14 operating simultaneously, each feeding to a conventional assembly ring 16 located downstream of the two lines 12, 14. Tire carcasses are assembled in the carcass line 12, and tire belt/tread packages are assembled in the belt/tread line 14. A carcass is joined to a respective belt/tread package in the assembly ring by pressure in a conventional way.

In the carcass line 12, carriers in the form of tire-building drums 20 are fed sequentially along an assembly path, i.e., from right to left in FIG. 1, past a number of component-applying stations 22a-22g of a suitable number. The drums can be fed in any suitable manner. For example, each drum could be mounted on a carrier, or chariot, which is advanced along a track comprised of rotatable wheels that rotate about respective horizontal axes. Other types of feed systems will be readily apparent to those skilled in the art.

Likewise, in the belt/tread, or other finished product, line 14, carriers in the form of cylinders 30 on which the belt/tread packages are assembled are fed past component-applying stations 32a-32c at which the green belt/tread components are applied to form a belt/tread package. The belt/tread line need not extend parallel to the carcass line, and in fact could be remotely located, with the belt/tread packages being transported to the assembly ring 16 if so desired.

At downstream ends of the lines 12, 14, a suitable transfer mechanism 40 is provided for positioning belt/tread packages and carcasses to the assembly ring 16.

At each of the product-applying stations 22a-22g (and 32a-32c), tire components for forming part of a tire carcass (or belt/tread package) are posed onto the drum or cylinder. Those components could be from reels 50 or from suitable and otherwise documented forms of integrated preparation. For example, at station 22c, four tire components, or poses, are wound on reels 54a-50d, located at respective pose positions. A specified length of each tire component is unwound from its respective reel and applied to the drum, as will be explained.

The assembly line according to the invention can be quickly and easily converted to make different types of tires, thereby making the use of an assembly line practicable for making tires in relatively short runs. In particular, the assembly line can be quickly and easily converted to pose components of either centralized preparation or integrated preparation, thereby optimizing the component pose technology.

The component reels 50 are mounted on mobile carriages 52-which can be easily moved in and out of position at any station (see FIG. 2). The carriages 52 are virtually identical to one another and the manner in which the carriages 52 interface to the station is identical. This makes them capable of being temporarily affixed at any position in any station. The stations possess identical types of fixed locators or positioning structures to which a carriage may be temporarily affixed in virtually any position. Thus, each carriage 52 can receive a reel carrying any type of tire component and can be quickly and easily maneuvered into virtually any position at any of the stations. Consequently, the assembly line can be conveniently converted from the manufacture of one type of tire to another type using only the precise number of stations and the precise number of pose positions needed for making the particular tire type. That enables the assembly line to be relatively short and no longer than needed for the number of components within the most complex tire within the portfolio of daily production. This minimizes the investment and floor space required for the assembly machine.

The carriages 52 can serve as adapters between differently configured storage reels of any factory to the standardized locators or positioning structures of the assembly machines. In other words, a given carriage 52 is able to receive differently configured storage reels and is able to be positioned anywhere along the assembly line. Accordingly, the assembly machine, when installed in to any factory or relocated between factories of different heritage does not require modification in order to adapt to the types of storage reels available. This allows a very flexible worldwide corporate manufacturing strategy that can adapt to changes in economic, political, or social environments.

By way of example, it can be seen that station 22c shown in FIG. 2 includes a drum positioning zone 42 in which the tire-building drum 20, mounted on a suitable mobile chariot 46, can be positioned for receiving tire components. The tire components that are to be applied to the drum at the station 22c are mounted on respective reels 50, more particularly designated as reels 50a-50d in FIG. 2, each reel being rotatably carried on a wheeled carriage 52, more particularly designated as carriages 52a-52d in FIG. 2. The carriages 52 are preferably of identical construction as noted earlier, and are mobile, preferably by being supported on castor wheels 54.

In the event that more than one pose is to be applied to the building drum at any given station, necessitating the presence of two or more reels 50 at the station, there would be provided one or more support tables 60, each of which overlies a respective carriage to guide a tire component being supplied from the next successive carriage. Thus, for example, four support tables 60a-60d are provided at station 22c (FIG. 2), and one support table 60e is provided at station 22f (FIGS. 3-4). Each support table preferably comprises a conveyor belt 62 (FIG. 4) which is driven to convey the particular tire component being supplied. For example, at station 22c (FIG. 2), the support table 60c supports a tire component D supplied by the reel 50d. Likewise, components B and C are supported by support tables 60a and 60b that are supplied by the reels 50a and 50b, respectively.

It will be appreciated that the components A-D are supplied one-at-a-time to the building drum 20 at the station 22c, the respective component approaching the drum along a feed path P oriented generally tangentially to the drum 20 (see FIG. 2). The product is fed at a feed site 70 by a respective feed device 70a-70d, shown in FIG. 2. The feed devices 70a-70d can be of any suitable conventional type, e.g., comprised of driven feed rollers which advance the component to a cutting site 80, as will be discussed. The feed devices 70a-70d are mounted on a common housing 71 for vertical indexing by a suitable actuator 72, in order to bring a respective feed device into alignment with the feed path P.

Situated downstream of the feed site 70 is the cutting site 80 which comprises a plurality of different conventional cutter devices 80a-80d suitable for cutting respective tire components. The cutter devices 80a-80d are mounted in a common housing 81 which is vertically indexible by a suitable actuator 82 in order to bring a respective cutter device into alignment with the feed path P.

It will be understood that the feed devices 70a-70d as well as the cutter devices 80a-80d are removable and replaceable by different feed and cutter devices, respectively, so that the feed site and the cutting site can be customized to handle the particular number and type of tire components being supplied at a given station.

In order to be able to quickly and easily remove, replace, or relocate the various elements of a machine (e.g. pose stations 42, carriage holders, support tables 60, cutter housing 81, integrated preparation component generators, assembly rings 16, or transfer mechanisms 40) for customization to tire type or pose technology, those machine elements, and the floor 90 on which they are supported are provided with cooperable, evenly spaced positioning structures that can be mated in order to fix the elements virtually anywhere on the floor. Preferably, the floor 90 is prepared with an array of positioning structures in the form of vertical holes 92 with reference pads, and each machine element is attached thereto by means of positioning structures in the form of projections 94 and conventional attachment hardware. It will be appreciated that by providing a large number of holes, the machine elements can be placed virtually anywhere on the floor and can be quickly released for removal or repositioning.

The floor 90 could be prepared with holes 92 by any number of methods, including the use of glued metal inserts in an existing floor, the use of preformed metal floor sections 90a, or a precision grid prepared before the concrete surface is poured. In this way, the floor area can be expanded by the preparation of a larger area. Thus, if an additional section is desired, a larger floor area is prepared. Should a smaller area be desired, the prepared holes can be covered or the preformed metal sections 90a could be removed.

Also, it would be possible to attach to the floor other mechanisms, e.g., the support tables, the feed housing 71, the cutter housing 81, etc., by similar projections, enabling those structures to be easily repositioned and/or replaced.

It will also be appreciated that the invention is applicable not only to the stations of the carcass line 12, but also to the stations of the finishing line 14. That is, the cylinders of the stations 32a-32c could be mounted on carriages 52 that are attached by projections to holes formed in the floor.

When setting-up the tire-making facility utilizing preformed floor sections 90a, the floor sections 90a are mounted on a sub-floor, and a suitable number of stations are established on the floor to form the carcass line 12 and the finishing line 14 of the assembly machine. Each station is established by providing a suitable number of tire components disposed on respective reels 50. The reels are attached to respective carriages 52, and the carriages are manually wheeled into position and secured to a carriage holder, which itself is secured by inserting the projections 94 into appropriate holes 92. Support tables 60 can be provided wherever necessary, and also secured to holes 92 by projections 94. The carriages and tables are positioned in alignment behind a feed housing 71 and a cutter housing 81. The feed housing 71 is provided with conventional feeding devices suited to the feeding of respective green tire components located at the station, and the cutter housing 81 is provided with conventional cutter devices suited to the cutting of the respective green tire components. The finishing line 14 can be similarly established on the floor 90.

The reels and carriages carrying green tire components provided at the stations are arranged in a pattern suited to the making of a particular type of tire. To complement this arrangement of components, the appropriate cutters 81 and feed devices 71 are installed into the cutter housing 80 and feed device housing 70. If it is desired to convert the machine to make a different type of tire, one could discuss at least four types of reconfiguration. The simplest case would be when the types of centralized preparation components that are posed at any position changes, but the quantity of poses at a station does not change. In that case, the existing carriage and its reel of component is removed and replaced with a new carriage and its reel of component. The cutter 81 and the feed device 71 for that pose position may be changed as well to suit the new type of component.

A second case could be where the quantity of centralized preparation prepared components needed to be posed at any station is increased. In that case an additional circuit of reel 50, carriage 52, carriage holder, support table 60, feed device 70, and cutter 80 are added to that station.

A third case could be where an additional pose station is required for additional centralized preparation components. In that case, the new station 22 could be added, along with the appropriate quantity of reels 50, carriages 53, carriage holders, support tables 60, feed devices 70, cutters 80, feed device housing 71 and a cutter housing 81.

A fourth case could be where a centralized preparation component is to be replaced by an integrated preparation component. In that case, the reel 50, carriage 52, carriage holder, support table 60, feed device 70, and cutter 80 are replaced by the integrated preparation system to fabricate, cut, and pose.

Converting the assembly line is accomplished quickly and easily by removing the projections 94 that secure the carriages that carry the particular components. Carriages carrying the tire components to be used in making the next type of tire can then be manually wheeled into place to form the new component pattern. The feed devices 70a-70d at the feed site can be replaced where necessary, and the cutter devices 80a-84d at the cutter site can be replaced where necessary.

Thus, in a matter of a relatively short period, the carcass line 12 or belt/tread line 14 can be converted to the making of a different type of tire, or to the utilization of a different pose technology.

Although the present invention has been described in connection with a preferred embodiment thereof, it will be appreciated by those skilled in the art that additions, deletions, modifications, and substitutions not specifically described may be made without departing from the spirit and scope of the invention as defined in the appended claims.

What is claimed is:

1. A tire building machine, comprising:
a conveying system for conveying carriers sequentially along an assembly path; and
a plurality of component-applying stations spaced apart along the path for applying green tire components to each carrier, the stations arranged on a support floor having an array of first positioning structures arranged throughout all of the stations, each station including:
at least one mobile carriage having second positioning structures releasably coupled with respective first positioning structures,
means for supplying a green tire component,
a feed mechanism for unwinding the green tire component from the reel and feeding the unwound component toward a carrier disposed at the respective station, and
a cutting mechanism for cutting the green tire component after a selected length thereof has been unwound.

2. The tire building machine according to claim 1 wherein the carrier comprises a tire-building drum, each of at least some of the stations including a plurality of mobile carriages arranged in a direction transversely of the assembly path, each carriage including a reel, the reels carrying different respective green tire components to be sequentially applied to the drum, the carriages comprising substantially identical second positioning structures releasably engaged with respective first positioning structures of the support floor.

3. The tire building machine according to claim 2 wherein each reel is mounted into a carriage and this carriage includes a mounting structure for connection with a receiving structure, wherein the carriage structures are substantially identical and the receiving structures are substantially identical to enable the carriages with their respective reels to be interchangeable relative to the pose position on the machine.

4. The tire building machine according to claim 3 wherein the cutting mechanism comprises a plurality of different cutter devices for cutting respective green tire components.

5. The tire building machine according to claim 4 wherein the cutting mechanism comprises a fixed frame in which the cutter devices are movable to bring a selected cutter device into a cutting position.

6. The tire-building machine according to claim 5 further including a support table arranged to guide a green tire component over a reel disposed thereahead in the respective station, each support table including positioning structures substantially identical to the second positioning structures for being releasably coupled to respective first positioning structures.

7. The tire building machine according to claim 1 wherein the first positioning structures comprise holes in the support floor, and the second positioning structures comprise projections releasably disposed in the holes.

8. The tire building machine according to claim 7 wherein the support floor is prepared with a standardized grid, onto which the respective machine elements can be attached, removed, and rearranged to the desired configuration for a desired tire's pose pattern.

9. The tire building machine according to claim 1 wherein each mobile carriage includes support wheels.

10. The tire-building machine according to claim 1 wherein the carrier comprises a cylinder for receiving green belt/tread components to form a belt/tread package.

11. The tire-building machine according to claim 2 wherein the assembly path constitutes a first assembly path, and further comprising a second assembly path arranged parallel to the first assembly path for making belt/tread packages.

12. The tire-building machine according to claim 11 further including an assembly ring disposed adjacent to the ends of the first and second assembly lines for bonding belt/tread packages received from the second assembly line to the tire carcasses received from the first assembly line.

13. A tire building machine, comprising:
a drum-conveying system for conveying tire-building drums sequentially along an assembly path; and
a plurality of component-applying stations spaced apart along the path for applying green tire components to each drum, the stations arranged on a support floor having an array of holes arranged throughout all of the stations, each station including:
a plurality of mobile carriages having projections releasably coupled with respective holes of the support floor, the projections of the carriages being identical wherein each carriage is selectively positionable on the support floor, reels releasably mounted on respective carriages and carrying different respective green tire components, each
reel enclosed in a mobile carriage including a mounting structure releasably coupled to a receiving structure of a respective carriage holder, wherein the mounting structures are substantially identical and the receiving structures are substantially identical so that the reels and respective carriage are mountable on any of the carriage holders,
a feed mechanism for unwinding the green tire components sequentially from the reels and feeding the unwound components toward a tire-building drum disposed at the respective station, and
a cutting mechanism comprising a plurality of different respective cutter devices for cutting the respective green tire components after a selected length thereof has been unwound.

14. The tire-building machine according to claim 13 wherein the cutter devices of each station are movable in a cutter housing to be sequentially placed in a cutting position.

15. A tire-building machine according to claim 13 wherein the pose technology for green components can be adapted to either centralized preparation components or integrated components by interchangeably mounting either the machine elements for centralized preparation components or the machine elements for integrated preparation components.

16. A tire building machine according to claim 13 wherein the machine can be integrated into any number of non-standardized factories using non-standardized component storage reels by using carriages of substantially identical mounting structures and holders of substantially identical receiving structures as adapters to provide a standard interface for a non-standard reel.

17. A tire building machine, comprising:
a drum-conveying system for conveying tire-building drums sequentially along an assembly path;
a plurality of component-applying stations spaced apart along the assembly path for applying green tire components to each drum, each station comprising:
a plurality of reels arranged one behind the other in a direction transversely of the assembly path, the reels carrying different respective green tire components,
a feeding mechanism for sequentially unwinding the green tire components from the reels, and
a cutting mechanism comprising a frame in which is disposed a plurality of different cutter devices for cutting respective green tire components that have been unwound, the cutter devices being movable within the frame for being selectively placed sequentially in a cutting position.

18. The tire-building machine according to claim 17 wherein the cutter devices are movable as a unit within the frame.

19. A method of converting a tire-making assembly line for making different types of tires, the assembly line comprising a plurality of stations for applying tire components to a drum conveyed sequentially past the stations, the stations arranged on a support floor having an array of first positioning structures arranged throughout all of the stations, each station including at least one carriage having second positioning structures releasably coupled to respective first positioning structures, wherein the green tire components of all of the stations define a first pattern of green tire components suited for making a first type of tire carcass, the method comprising replacing the first pattern of green tire components with a second pattern of green tire components for making a second type of tire carcass, different from the first type, by:
disconnecting the second positioning structures from the respective first positioning structures to disconnect the carriages, and relocating the disconnected carriages,
moving carriages carrying green tire components for forming the second pattern, and orienting those carriages to form the second pattern; and
securing the carriages forming the second pattern by connecting second positioning structures thereof to respective first positioning structures.

20. The method according to claim 19 wherein step A comprises removing second positioning structures in the form of projections from first positioning structures in the form of holes, and step C comprises inserting second positioning structures in the form of projections into first positioning structures in the form of holes.
